(19) United States
(12) Patent Application Publication
(10) Pub. No.: US 2006/0285358 A1
(43) Pub. Date: Dec. 21, 2006

(54) Display frame having a light source to provide back illumination

(76) Inventors: Jui Chia Chen, Shanghai (CN); Michael Po Shen, Shanghai (CN)

Correspondence Address: PRO-TECHTOR INTERNATIONAL SERVICES, 20775 NORADA CT., SARATOGA, CA, 95070, US

(21) Appl. No.: 11/357,379

(22) Filed: Feb. 18, 2006

(30) Foreign Application Priority Data
Jun. 20, 2005 (CN) 200510026936.2
Jun. 20, 2005 (CN) 200510026937.7

(51) Int. Cl. F21V 7/04; B64D 47/06

(52) U.S. Cl. 362/613; 362/559

(57) ABSTRACT

A display frame is disclosed having a base frame, a LED light source mounted inside the base frame, a light guide board mounted inside the base frame and peripherally facing the light source and having a net of dots on the back surface for dispersing light rays from the light source to provide sufficient back illumination to the photo or picture supported on the light guide board. The base frame has a frame body formed of frame bars, and clamping plates hinged to the frame bars and forced by spring members between the frame bars and the clamping plates to hold down a photo or picture on the light guide board for display.

### BACKGROUND OF THE INVENTION

1. Field of the Invention

The present invention relates to a display frame for displaying a photo or picture and more particularly, to a display frame having a light source to provide back illumination.

2. Description of the Related Art

Picture frames are commonly used in our daily life to display photos or pictures. A conventional picture frame comprises a rectangular base frame, a stiff backing, and a transparent face glass. The photo or picture to be displayed is set in between the stiff backing and the transparent face glass within the rectangular base frame. The mounting arrangement of the base frame, the stiff backing and the transparent face glass is complicated. It is inconvenient to install and replace the photo or picture. Further, conventional picture frames do not provide a light source. Illumination relies upon an external light source. Therefore, external light rays may affect the display quality of the photo or picture.

Further, advertising lamp boxes are commonly seen in our daily life. An advertising lamp box has a box and a lamp tube mounted inside the box to provide illumination. The use of a lamp tube in an advertising lamp box as light source means has the drawbacks of big dimension, high energy consumption, and high maintenance cost.

### SUMMARY OF THE INVENTION

The present invention has been accomplished under the circumstances in view.

It is one object of the present invention to provide a display frame having a light source to provide back illumination, which is practical for use as a picture frame that eliminates the drawback of conventional picture frames to be difficult to change the display photo or picture and the drawback of conventional picture frames to have no back illumination.

It is another object of the present invention to provide a display frame having a light source to provide back illumination, which is practical for use as an advertising lamp box that eliminates the drawbacks of conventional advertising lamp boxes to have a big size, high power consumption and high maintenance cost.

According to one aspect of the present invention, the display frame comprises a base frame, a LED light source mounted inside the base frame, a light guide board mounted inside the base frame and peripherally facing the light source and having a net of dots on the back surface for dispersing light rays from the light source to provide sufficient back illumination to the photo or picture supported on the light guide board.

According to another aspect of the present invention, a light shade film is bonded to the back surface of the light guide board, preventing passing of light rays through the back side of the light guide board.

According to still another aspect of the present invention, the base frame has a frame body formed of frame bars, and clamping plates hinged to the frame bars and forced by spring members between the frame bars and the clamping plates to hold down a photo or picture on the light guide board for display.

According to still another aspect of the present invention, a transparent lens is set in front of the light guide board, keeping the photo or picture sandwiched between the light guide board and the transparent lens.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view showing the outer appearance of a display frame according to the present invention.

FIG. 2 is an exploded view of the display frame according to the present invention.

FIG. 3 is a front view of the display frame according to the present invention.

FIG. 4 is a cross sectional view taken along line 4-4 of FIG. 3.

FIG. 5 is a cross sectional view of the present invention, showing the clamping plates opened.

FIG. 6 is a cross sectional view of the present invention, showing the display frame used in an advertising lamp box and a picture secured to the light guide board by the clamping plates and the springs.

### DETAILED DESCRIPTION OF THE PREFERRED EMBODIMENT

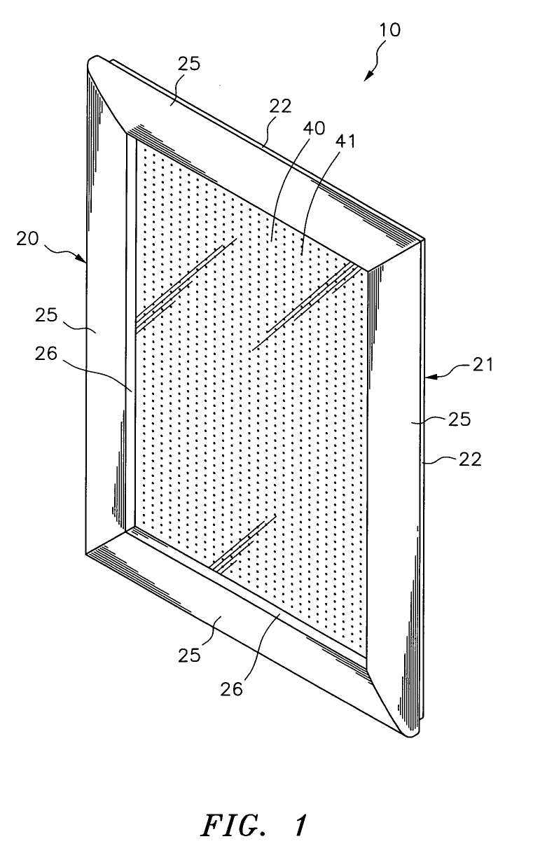

Referring to FIGS. 1˜4, a display frame 10 in accordance with the present invention is shown comprising a base frame 20. The base frame 20 is comprised of a frame body 21 and a plurality of clamping plates 25. According to the present preferred embodiment, the frame body 21 is formed of four frame bars 22 and four angle plates 23, configuring a rectangular shape. The rectangular frame body 21 is simply an example for understanding of the present invention but not a limitation. Alternatively, the frame body 21 can be made having a square, oval, circular, or polygonal design.

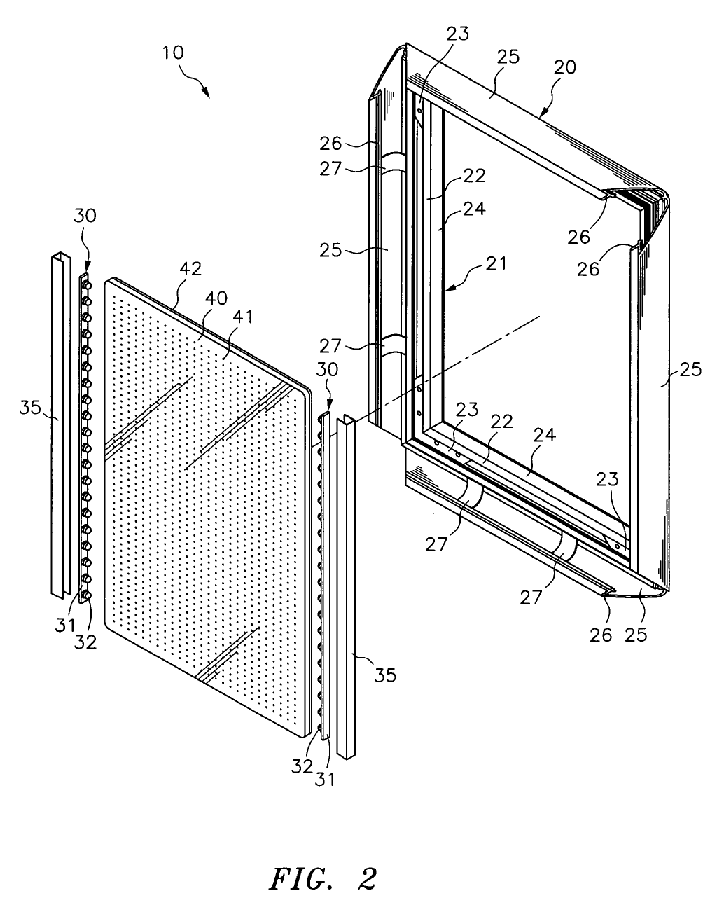

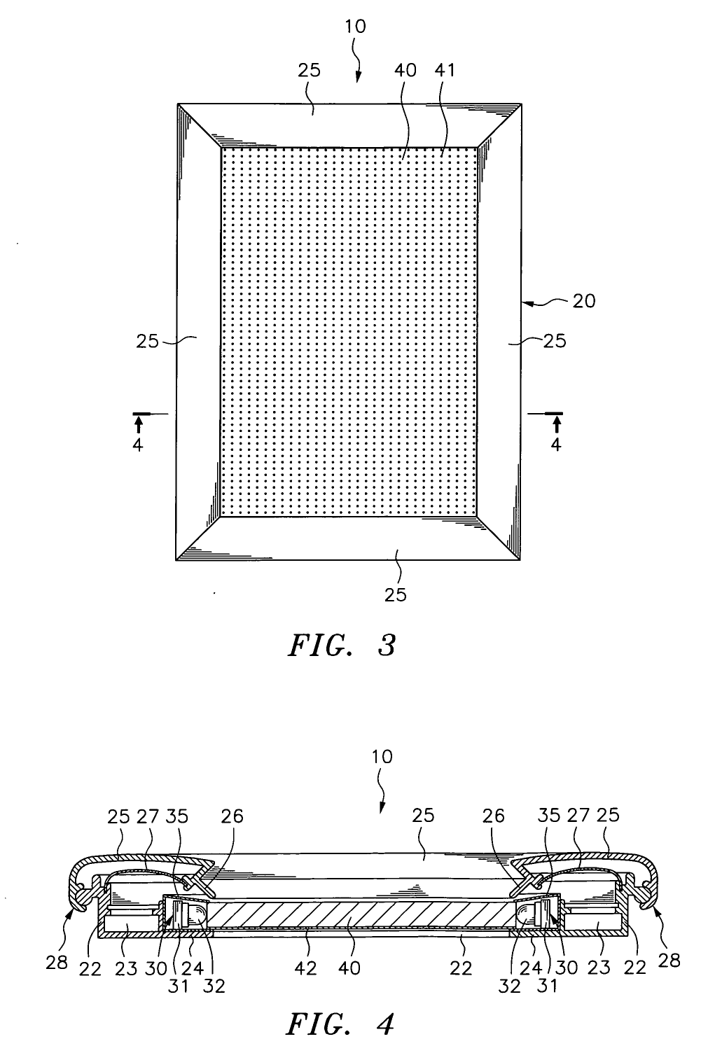

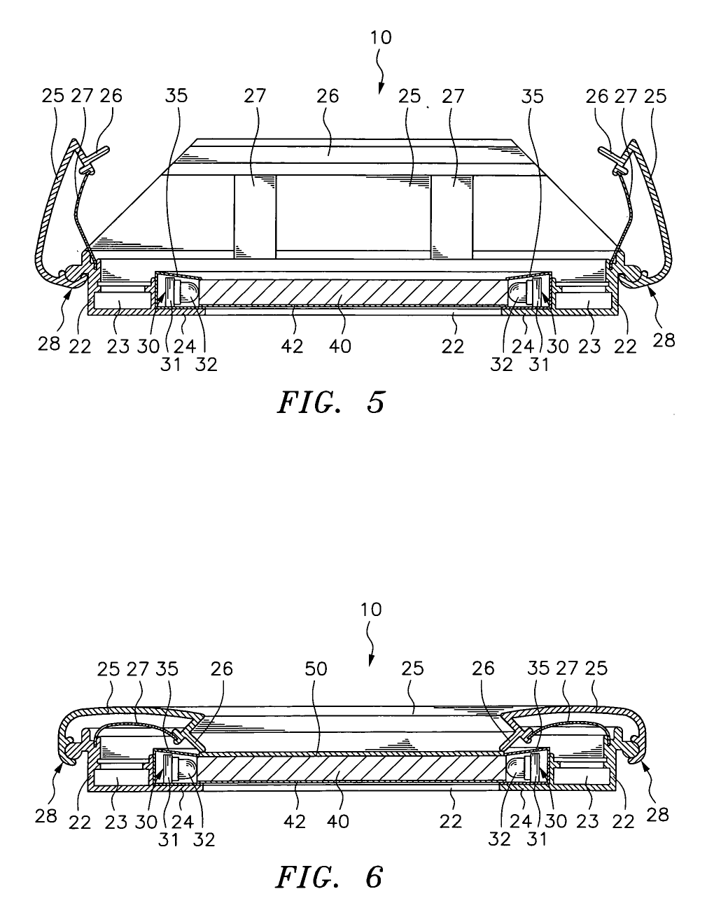

The aforesaid clamping plates 25 are arranged at the front side of the frame body 21. As shown in FIGS. 2 and 4, the clamping plates 25 are respectively connected to the frame bars 22 by a respective hinge 28. Therefore, the clamping plates 25 can be turned relative to the frame body 21 between a close position as shown in FIGS. 1, 3 and 4, and an open position as shown in FIGS. 2 and 5. Each clamping plate 25 has an outer side connected to the associating hinge 28 and an inner side terminating in a retaining portion 26. By means of the respective retaining portion 26, each clamping plate 25 holds down a photo or picture 50 (see FIG. 6). Further, two spring members 27 are connected between each clamping plate 25 and the associating frame bar 22, imparting a pressure to the associating clamping plate 25 to hold down a photo or picture 50 on a light guide board 40. According to the present preferred embodiment, the spring members 27 are flat springs.

Another important part of the present invention is the arrangement of a light source 30 within the base frame 20. According to the present preferred embodiment as shown in FIGS. 2 and 4, the light source 30 is comprised of two narrow elongated circuit boards 31, a plurality of LEDs (Light Emitting Diodes) 32 respectively soldered to the circuit boards 31, and two channel bars 35 adapted to accommodate the circuit boards 31 respectively. The channel bars 35 protect the circuit boards 31 and the LEDs 32, and concentrate light rays from the LEDs 32 onto the light guide board 40. The invention uses LEDs to emit light for the advantages of long service life and low power consumption. Further, the use of LEDs allows thin size design of the display frame 10. Further, the frame bars 22 each have a base portion 24. The channel bars 35 are affixed to the base portions 24 of the two frame bars 22 at two opposite lateral sides (long sides) of the base frame 20.

The aforesaid light guide board 40 is mounted inside the base frame 20. As shown in FIGS. 2 and 4, the light guide board 40 can be moulded from PMMA (Polymethylmetharylate) or PC (Polycarbonate) in a shape fitting the display side of the base frame 20. According to the present preferred embodiment, the light guide board 40 is a rectangular plate member having the four sides respectively affixed to the base portions 24 of the frame bars 22 and the two opposite long sides respectively engaged into the two opposite channel bars 35 that are respectively affixed to the base portions 24 of the two frame bars 22 at two opposite lateral sides (long sides) of the base frame 20. Further, the light guide board 40 has a net of dots 41 longitudinally transversely aligned on the back surface thereof, and a light shade film 42 bonded to the back surface. The net of dots 41 is printed on the back surface of the light guide board 40 in a clean room. Further, the net of dots 41 is adapted to have light rays produced by the LEDs 32 be evenly dispersed through the whole area of the light guide board 40. The light shade film 42 presents passing of light through the back surface of the light guide board 40, thereby gathering light rays. The light guide board 40, the light shade film 42 and the channel bars 35 can be fixedly positioned by means of the use of an adhesive or other proper measures. Further, an opaque film, such as aluminium foil or tin foil may be wrapped about the connection area between the light guide board 40 and the channel bars 35 to prevent dispersion of light rays through the gap in between the light guide board 40 and the channel bars 35.

The position of the light source 30 is determined subject to the size of the light guide board 40. For example, for a small light guide board 40, the light source 30 can be mounted in one lateral side within the base frame 20; for a medium size light guide board 40, the light source 30 can be installed in the two opposite lateral sides within the base frame 20; for a big light guide board 40, the light source 30 can be installed in the four sides within the base frame 20. According to the present preferred embodiment, the light source 30 is installed in the left and right sides within the base frame 20.

The display frame 10 of the present invention can be used as a photo frame, picture frame, advertising lamp box, or the like.

When in use, the four clamping plates 25 are opened from the base frame 20 (see FIG. 5), and then the selected photo or picture 50 is placed on the light guide board 40, and then the clamping plates 25 are closed to hold down the photo or picture 50 on the light guide board 40 (see FIG. 6), and then the light source 30 is connected to power source and turned on. At this time, the LEDs 32 emit light toward the light guide board 40, and the net of dots 41 disperse light rays from the LEDs 32 evenly to illuminate the back side of the photo or picture 50, providing a high display quality.

In order to protect the photo or picture 50, a transparent lens (not shown) is used and pressed on the light guide board 40, keeping the photo or picture 50 sandwiched between the light guide board 40 and the transparent lens. Further, a light source controller may be used to control the flashing mode of the LEDs 32, producing a visual effect.

Comparing to conventional designs, the invention provides an active and prominent display effect. The invention uses the clamping plates 25 and the springs 27 at the four sides of the base frame 20 to hold down a photo or picture 50 for display. This arrangement facilitates mounting/dismounting of the photo or picture 50. Further, the LED light source 30 and the light guide board 40 are provided inside the base frame 20 to provide back illumination, improving the display quality of the photo or picture 50. Therefore, the display of the photo or picture 50 is free from the interference of external light. Further, the use of the LEDs 32 enables the display frame 10 to be made relatively thinner.

Although a particular embodiment of the invention has been described in detail for purposes of illustration, various modifications and enhancements may be made without departing from the spirit and scope of the invention.

What the invention claimed is:

1. A display frame comprising:
a base frame;
a light source, said light source comprising a plurality of light emitting diodes mounted inside said base frame; and
a light guide board mounted inside said base frame, said light guide board having at least one peripheral side thereof facing said light source, and a net of dots at a back surface thereof adapted to disperse light rays from said light emitting diodes of said light source through said light guide board.

2. The display frame as claimed in claim 1, wherein said base frame comprises:
a frame body formed of a plurality of frame bars configuring a predetermined shape;
a plurality of clamping plates respectively connected to said frame bars of said frame body, said clamping plates each having a first side respectively connected to said frame bars of said frame body by a respective hinge and a second side opposite to said first side; and
a plurality of spring members respectively connected between the second sides of said clamping plates and said frame bars of said frame body.

3. The display frame as claimed in claim 2, wherein said frame bars of said frame body each have a base portion; said light source further comprises at least one channel bar fastened to at least the base portion of one of said frame bars of said frame body and adapted to accommodate said light emitting diodes, said at least one channel bar each having an open side facing said light guide board; said light guide board has at least one peripheral side inserted into said at least one channel bar.

4. The display frame as claimed in claim 3, further comprising at least one opaque film respectively wrapped about the connection area between said light guide board and said at least one channel bar.

5. The display frame as claimed in claim 2, wherein said spring members are flat springs.

6. The display frame as claimed in claim 2, further comprising a transparent lens set between said clamping plates and said light guide board.

7. The display frame as claimed in claim 1, further comprising a light source controller adapted to control the operation of said light emitting diodes.

8. The display frame as claimed in claim 1, wherein said light guide board has a light shade film bonded to the back surface thereof.

9. The display frame as claimed in claim 1, further comprising a transparent lens covered on a front surface of said light guide board.
